(19) United States
(12) Patent Application Publication
(10) Pub. No.: US 2026/0341690 A1
(43) Pub. Date: Oct. 29, 2026

(54) SECONDARY BATTERY AND SECONDARY BATTERY CASE

(71) Applicant: SAMSUNG SDI CO., LTD., Yongin-si (KR)

(72) Inventor: Hyunggi KIM, Yongin-si (KR)

(21) Appl. No.: 19/567,698

(22) Filed: Mar. 16, 2026

(30) Foreign Application Priority Data
Apr. 28, 2025 (KR) 10-2025-0055113

(51) Int. Cl. H01M 4/38; H01M 50/103; H01M 50/119; H01M 50/15; H01M 50/159

(52) U.S. Cl. CPC H01M 4/386; H01M 50/103; H01M 50/119; H01M 50/15; H01M 50/159; H01M 2220/30

(57) ABSTRACT

A secondary battery according to some embodiments of the present disclosure may include an electrode assembly including a first electrode, a second electrode, and a separator; a case body having an opening on a side of the case body and accommodating the electrode assembly, the case body including a first active material layer coated on an inner side of the opening that faces the electrode assembly; and a case cover sealing the opening of the case body, the case cover including a second active material layer coated on a surface of the case cover that faces the electrode assembly.

### CROSS-REFERENCE TO RELATED APPLICATION

This application claims priority under 35 U.S.C. § 119 to Korean Patent Application No. 10-2025-0055113, filed in the Korean Intellectual Property Office on Apr. 28, 2025, the entire contents of which are hereby incorporated by reference.

### BACKGROUND

### 1. Field

The present disclosure relates to a secondary battery and a secondary battery case.

### 2. Description of Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and are widely used for storing power (e.g., home and/or utility scale power storage). A secondary battery generally includes an electrode assembly composed of a positive electrode and a negative electrode, a case accommodating the electrode assembly, and electrode terminals connected to the electrode assembly.

Recently, user needs for reducing the weight of secondary batteries have emerged in small-sized portable IT devices and in automobiles. Also, there is a growing demand for increasing the energy density and the capacity of the secondary batteries.

The above information disclosed in this Background section is for enhancement of understanding of the background of the present disclosure, and, therefore, it may contain information that does not constitute related (or prior) art.

### SUMMARY

The present disclosure aims to provide a secondary battery and a secondary battery case for solving the problems described above.

These and other aspects and features of the present disclosure will be described in or will be apparent from the following description of embodiments of the present disclosure.

A secondary battery according to some embodiments of the present disclosure may include an electrode assembly including a first electrode, a second electrode, and a separator; a case body having an opening on a side of the case body and accommodating the electrode assembly, the case body including a first active material layer coated on an inner side of the opening that faces the electrode assembly; and a case cover sealing the opening of the case body, the case cover including a second active material layer coated on a surface of the case cover that faces the electrode assembly.

In some embodiments, the electrode assembly contacts the case body and the case cover.

In some embodiments, a surface of the electrode assembly contacts the first active material layer coated on the inner side of the opening of the case body. Another surface of the electrode assembly contacts the second active material layer coated on the surface of the case cover.

In some embodiments, the first active material layer of the case body and the second active material layer of the case cover contact the separator of the electrode assembly.

In some embodiments, the electrode assembly may be a stacked-type electrode assembly where the first electrode, the separator, and the second electrode may be sequentially stacked.

In some embodiments, the case body and the case cover may include stainless-use steel.

In some embodiments, a content of a silicon-based active material included in the first active material layer or included in the second active material layer may be greater than a content of the silicon-based active material included in an active material layer of the first electrode or an active material layer of the second electrode.

In some embodiments, the first active material layer and the second active material layer each may have a content of silicon-based active material greater than or equal to 30 wt %.

In some embodiments, a thickness of the first active material layer or a thickness of the second active material layer may be greater than a thickness of an active material layer coated on a surface of the first electrode or a thickness of an active material layer coated on a surface of the second electrode.

In some embodiments, a thickness of the first active material layer or a thickness of the second active material layer may be at least 102% of a thickness of an active material layer coated on a surface of the first electrode or a thickness of an active material layer coated on a surface of the second electrode.

In some embodiments, a coating area of the first active material layer or a coating area of the second active material layer may be greater than an area of an active material layer coated on a surface of the first electrode or an area of an active material layer coated on a surface of the second electrode.

In some embodiments, a coating area of the first active material layer or a coating area of the second active material layer may be 110% of an area of an active material layer coated on a surface of the first electrode or an area of an active material layer coated on a surface of the second electrode.

In some embodiments, a length in a first direction of the first active material layer or a length in the first direction of the second active material layer may be greater than a length in the first direction of an active material layer coated on a surface of the first electrode or a length in the first direction of an active material layer coated on a surface of the second electrode. A length in a second direction, perpendicular to the first direction, of the first active material layer or a length in a second direction of the second active material layer may be greater than a length in the second direction of the active material layer coated on the surface of the first electrode or a length in the second direction of the active material layer coated on the surface of the second electrode.

In some embodiments, a length in a first direction of the first active material layer or a length in a first direction of the second active material layer may be at least 102% of a length in the first direction of an active material layer coated on a surface of the first electrode or a length in the first direction of an active material layer coated on a surface of the second electrode. A length in a second direction, perpendicular to the first direction, of the first active material layer or a length in the second direction of the second active material layer may be at least 102% of a length in the second direction of the active material layer coated on the surface of the first electrode or a length in the second direction of the active material layer coated on the surface of the second electrode.

A method of providing active material layers for the secondary battery of claim according to some embodiments of the present disclosure may include using a gravure roller to coat the first active material layer onto the case body and using a gravure roller to coat the second active material layer onto the case cover.

A secondary battery case according to some embodiments of the present disclosure may include a case body having an opening on a side of the case body and accommodating an electrode assembly, the case body including a first active material layer coated on an inner side of the opening that faces the electrode assembly and a case cover sealing an opening of the case body, the case cover including a second active material layer coated on a surface that faces the electrode assembly.

In some embodiments, the case body and the case cover may include stainless use steel.

In some embodiments, the first active material layer and the second active material layer each may have a content of silicon-based active material greater than or equal to 30 wt %.

In some embodiments, a thickness of the first active material layer and a thickness of the second active material layer may be each from about 60 μm to about 70 μm.

A method of providing active material layers for the secondary battery case according to some embodiments of the present disclosure may include using a gravure roller to coat the first active material layer onto the case body and using a gravure roller to coat the second active material layer onto the case cover.

According to some embodiments of the present disclosure, the active material layer coated on the case body and the case cover may have a greater content of silicon-based active material than a negative electrode material layer in the electrode assembly. Therefore, the expansion of the active material layer coated on the case body and the case cover enables maintained contact between the electrode assembly and the active material layers coated on the case. Accordingly, a packing ratio of the electrode assembly of the secondary battery may be maximized.

However, aspects and features of the present disclosure are not limited to those described above, and other aspects and features not mentioned will be clearly understood by a person skilled in the art from the detailed description, the drawings, and/or the claims of the present disclosure.

### BRIEF DESCRIPTION OF DRAWINGS

The following drawings attached to this specification illustrate some embodiments of the present disclosure and further describe aspects and features of the present disclosure together with the detailed description of the present disclosure. The present disclosure should not be construed as being limited to the drawings.

FIG. 1 is a perspective view illustrating a secondary battery according to some embodiments of the present disclosure.

FIG. 2 is an exploded perspective view illustrating a battery cell according to some embodiments of the present disclosure.

FIG. 3 is a view illustrating a case body according to some embodiments of the present disclosure.

FIG. 4 is a view illustrating a case cover according to some embodiments of the present disclosure.

FIG. 5 is a cross-sectional view illustrating an electrode assembly according to some embodiments of the present disclosure.

FIG. 6 is a cross-sectional view illustrating a secondary battery according to some embodiments of the present disclosure.

FIG. 7 is a illustrates differences in width, length, and area between an active material layer coated on a case cover and an active material layer of a second electrode according to some embodiments of the present disclosure.

FIG. 8 is a schematic view illustrating a battery electronic device according to some embodiments of the present disclosure.

FIG. 9 is a view illustrating a battery module arranged in an electronic device according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements and/or layers may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” and “upper,” may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lesser numerical limitations subsumed therein, and any minimum numerical limitation recited in this specification is intended to include all greater numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements and/or features as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.”

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the case of a secondary battery using an electrode assembly in which at least one first electrode, at least one separator, and at least one second electrode are sequentially stacked, an electrode assembly finish that uses a negative electrode or a separator may be necessary. Specifically, in the case of a small-sized secondary battery mounted in the electronic device, an electrode assembly may be finished by using a half-anode electrode plate to maximize the capacity within a limited size and thickness.

However, for the half-anode electrode plate, in which only one side of the substrate is coated with an active material, curling may occur where an electrode plate is rolled toward the substrate due to a difference in elongation between the substrate and the composite layer after rolling. Accordingly, curling may be alleviated by thickening the substrate during the finishing of the electrode assembly using the half-anode electrode plate, or reducing the thickness of the active material. However, this may cause a reduction in battery capacity.

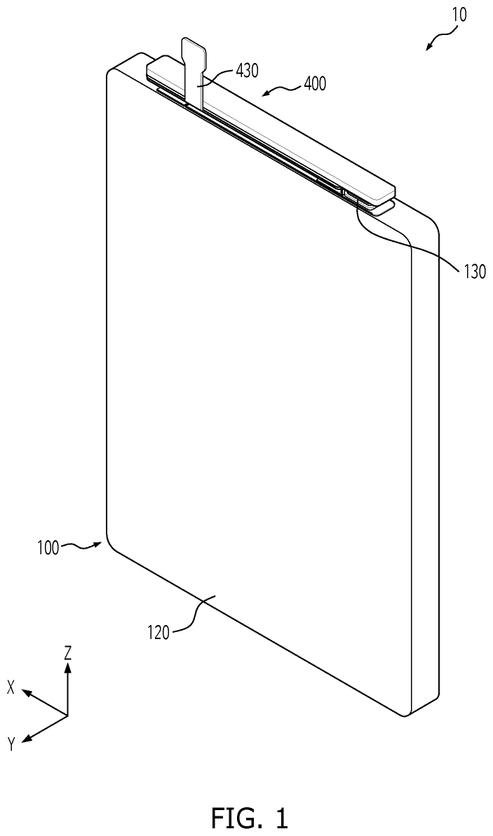

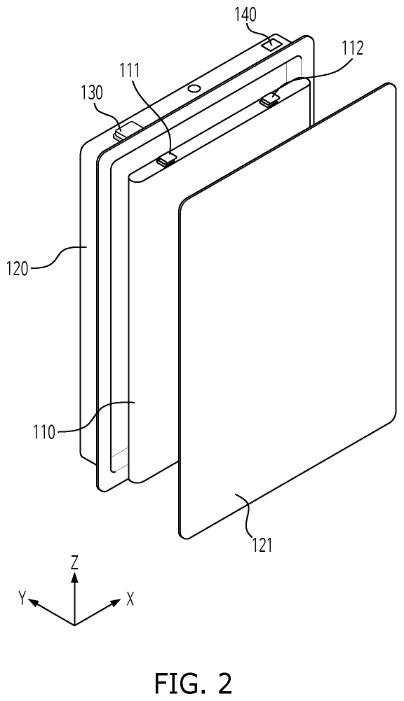

FIG. 1 is a perspective view illustrating a secondary battery 10 according to some embodiments of the present disclosure. FIG. 2 is an exploded perspective view illustrating a battery cell 100 according to some embodiments of the present disclosure.

Referring to FIG. 1 and FIG. 2, a secondary battery 10 may include a battery cell 100, an electrode assembly 110, a case body 120, a case cover 121, and a protective circuit module 400. FIGS. 1 and 2 illustrate, at the left bottom of each figure, a first direction (X direction), which is a virtual direction for the purpose of helping understanding, a second direction (Z direction) orthogonal to the first direction, and a third direction (Y direction) orthogonal to the first and second directions.

The battery cell 100 may include an electrode assembly 110, a case body 120 configured to accommodate the electrode assembly 110, a first electrode terminal 130 provided on one side of the case body 120, a second electrode terminal 140, and a case cover 121.

The electrode assembly 110 may include at least one first electrode, at least one second electrode, and at least one separator. The electrode assembly 110 may be a stacked-type electrode assembly in which at least one first electrode, at least one separator, and at least one second electrode are sequentially stacked. The electrode assembly 110 may further include a first electrode tab 111 and a second electrode tab 112. The first electrode may perform as a positive electrode, and the second electrode may function as a negative electrode. However, the electrode assembly 110 described above is exemplary, and the present disclosure is not limited thereto.

The electrode assembly 110 may be configured to contact the case body 120 and the case cover 121. Specifically, one surface of the electrode assembly 110 may contact a first active material layer coated on the inner side of an opening of the case body 120, and another surface of the electrode assembly 110 may contact a second active material layer coated on one side of the case cover 121.

The first electrode tab 111 may be separately formed and connected to a non-coated part of the first electrode or may be formed by punching part of the non-coated part. The first electrode tab 111 may be extended from the non-coated part and connected to the first electrode terminal 130. The first electrode tab 111 may be a passage for a current flow between the first electrode and the first electrode terminal 130.

The second electrode tab 112 may be separately formed and connected to the non-coated part of the second electrode or may be formed by punching part of the non-coated part. The second electrode tab 112 may be extended from the non-coated part and may be electrically connected to the case body 120. The second electrode tab 112 may be a passage for a current flow between the second electrode and the case body 120. The second electrode tab 112 may be electrically connected to the second electrode terminal 140. The second electrode tab 112 may be a passage for a current flow between the second electrode and the second electrode terminal 140.

The case body 120 and the case cover 121 may form an overall exterior of the battery cell 100. The case body 120 and the case cover 121 may include stainless-use steel (SUS). An energy density of the secondary battery 10 may be increased by coating an active material layer on the case itself including stainless steel to use as a half-anode electrode plate. In the case of an aluminum pouch cell, an insulating layer may be coated on the aluminum pouch to ensure flexible vinyl-like properties and safety, which is inappropriate for coating an active material layer onto the case. However, the case including stainless-steel may have a rigidity unlike an insulated and coated aluminum pouch and may not be crumpled, which enables active material coating. By coating the active material layer on the case itself including stainless steel, the energy density of the secondary battery 10 may increase by removing one electrode (or electrode plate) from each of the uppermost end electrode (or electrode plate) and the lowermost end electrode (or electrode plate) of the electrode assembly, a total of two (2) electrodes.

The case body 120 may include an opening on one side for accommodating the electrode assembly 110. After the electrode assembly 110 is accommodated in the case body 120, the case cover 121 configured to seal the opening of the case body 120 may cover the open surface of the case body 120. The case cover 121 may be coupled to the case body 120 by welding or other means, thereby sealing the electrode assembly 110 from the outside.

The case body 120 may include a first active material layer coated on the inner side of the opening that faces the electrode assembly 110. The case cover 121 may include a second active material layer coated on one side that faces the electrode assembly 110. After the case body 120 accommodates the electrode assembly 110, one side of the electrode assembly 110 may contact the first active material layer coated on the inner surface of the opening of the case body 120, and another side of the electrode assembly 110 may contact the second active material layer coated on one side of the case cover 121. The first active material layer of the case body 120 and the second active material layer of the case cover 121 may contact at least one separator of the electrode assembly 110.

According to some embodiments, a content of the silicon-based active material included in the first active material layer and the second active material layer may be greater than a content of the silicon-based active material included in the active material layer of the first electrode or the second electrode of the electrode assembly 110. The content of the silicon-based active material in the first active material layer and the second active material layer may be greater than or equal to 30 wt %. Accordingly, due to an expansion of the active material layer (e.g., a negative electrode active material layer), the first active material layer and the second active material layer coated onto the case body 120 and the case cover 121 may be in contact with the electrode assembly 110. Accordingly, a packing ratio of the electrode assembly 110 of the secondary battery 10 (i.e., a ratio of the second direction thickness of the electrode assembly 110 compared to the second direction thickness of the opening of the case) may be maximized.

The first electrode terminal 130, the second electrode terminal 140, and an electrolyte injection hole may be provided on a first side surface of the case body 120. The electrolyte injection hole may be disposed between the first electrode terminal 130 and the second electrode terminal 140, but the present disclosure is not limited thereto. After the electrolyte is injected, the electrolyte injection hole may be sealed by a sealer.

The first electrode terminal 130 may be disposed on one side of the case body 120. The first electrode terminal 130 may penetrate one side of the case body 120. An insulating gasket may be disposed between the first electrode terminal 130 and the case body 120, and the first electrode terminal 130 may be insulated from the case body 120 through an insulating gasket. The first electrode terminal 130 may be electrically connected to the first electrode of the electrode assembly 110. The first electrode terminal 130 may be electrically connected to the first electrode through a first electrode tab 111. The first electrode terminal 130 may be electrically connected to the first electrode and may function as a positive electrode.

The second electrode terminal 140 may be spaced apart from the first electrode terminal 130 in the first direction and may be disposed on one side of the case body 120. The second electrode terminal 140 may be electrically connected to the case body 120. Unlike the first electrode terminal 130, the second electrode terminal 140 may contact the case body 120. The second electrode terminal 140 may be electrically connected to the second electrode of the electrode assembly 110. The case body 120 may be electrically connected to the second electrode through a second electrode tab 112. The second electrode terminal 140 may be electrically connected to the second electrode through the case body 120 and the second electrode tab 112. The case body 120 and the second electrode terminal 140 may be electrically connected to the second electrode and may function as a negative electrode.

The first electrode terminal 130 and the second electrode terminal 140 may be electrically connected to a protective circuit module 400. The protective circuit module 400 may be electrically connected to the battery cell 100 and may prevent heating and explosion that occur due to overcharging, over-discharging, and an overcurrent. The protective circuit module 400 may measure the voltage of the battery cell 100 and the current that flows through the battery cell 100 through the first electrode terminal 130 and the second electrode terminal 140. The protective circuit module 400 may include safety elements made of passive elements such as resistors and capacitors or active elements such as field-effect transistors, or protective circuit elements in which integrated circuits are selectively formed.

The protective circuit module 400 may include a flexible printed circuit board. The protective circuit module 400 may include a connector (not shown) connected to an external device on a surface of a withdrawal part 430 that withdraws from one side. The protective circuit module 400 may be connected to the external device through the connector (not shown). The protective circuit module 400 may transmit electrical energy stored in the battery cell 100 to the external device or may receive a control signal that controls the operation of the battery cell 100 from the external device.

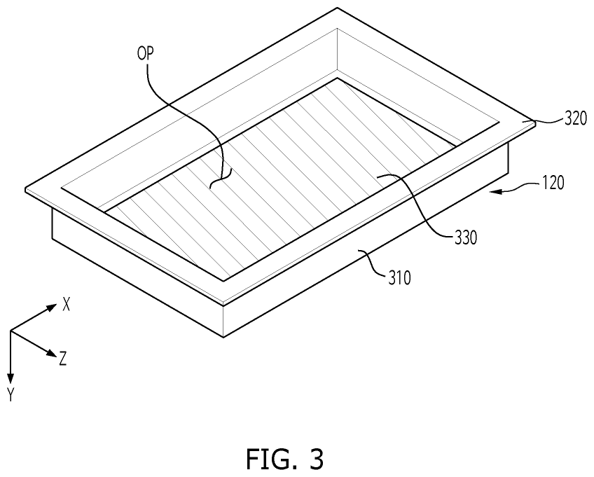

FIG. 3 is a view illustrating the case body 120 according to some embodiments of the present disclosure.

The case body 120 may include an opening OP configured to accommodate an electrode assembly (not shown), a first active material layer 330 coated on the inner side of the opening OP that faces the electrode assembly, a case body side part 310, and a flange part 320 disposed along the periphery of one open side of the case body 120.

The case body 120 may include stainless steel. Accordingly, an active material (e.g., a negative electrode active material) may be coated on the case body 120 so that the case body 120 may function as a negative electrode. The case body 120 may function as a negative electrode current collector.

For a method of coating the case of the secondary battery with an active material layer, the first active material layer 330 may be coated by using a gravure roller.

A thickness of the first active material layer 330 may be from about 60 μm to about 70 μm.

When the case body 120 accommodates the electrode assembly in the opening OP, the flange part 320 may be coupled to the case cover (not shown) through welding. Accordingly, the open surface of the opening OP may be sealed by the case cover (not shown). After welding, the flange part 320 may be partially removed by cutting.

FIG. 3 illustrates a structure of the case body 120 including the flange part 320, but the present disclosure is not limited thereto. The case cover may be coupled to the case body without the flange part 320.

The first active material layer 330 may contact at least one separator of the electrode assembly. Accordingly, the electrode assembly may contact the first active material layer 330.

A content of the silicon-based active material included in the first active material layer 330 may be greater than a content of the silicon-based active material included in the active material layer of the first electrode or the second electrode included in the electrode assembly. The first active material layer 330 may have a content of the silicon-based active material at 30 wt % or more. Accordingly, the first active material layer 330 applied to the case body 120 may maintain contact with the electrode assembly.

In some embodiments, the thickness of the first active material layer 330 may be at least 102% of the thickness of the active material layer coated on a surface of at least one of the first electrode or the second electrode included in the electrode assembly. In some embodiments, the coating area of the first active material layer 330 may be at least 110% of the area of the active material layer coated on a surface of at least one of the first electrode or the second electrode. Accordingly, the energy density and the capacity of the secondary battery may increase.

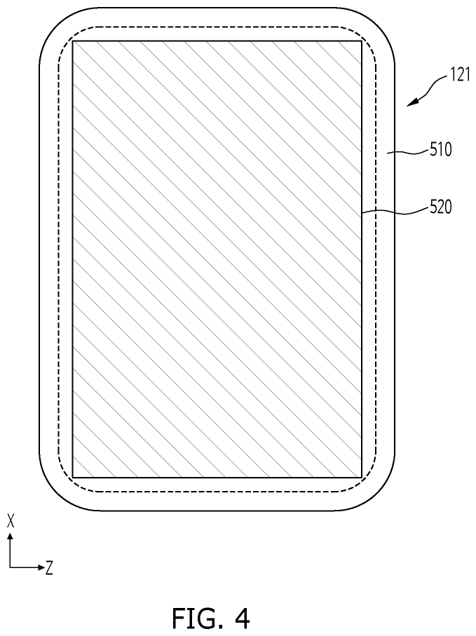

FIG. 4 is a view illustrating a case cover 121 according to some embodiments of the present disclosure.

The case cover 121 may include a second active material layer 520 coated on a surface that faces an electrode assembly (not shown).

The case cover 121 may include stainless steel. Accordingly, the case cover 121 may be coated with an active material to function as a negative electrode. The case cover 121 may function as a negative electrode current collector.

The case cover 121 may seal the opening of the case body that accommodates the electrode assembly by welding with the case body or by other means. An edge 510 of the case cover 121 may contact the flange part of the case body. After welding, part of the flange part of the case body may be removed by cutting and part of the edge 510 of the case cover may be removed by cutting.

A second active material layer 520 may contact at least one separator of the electrode assembly. Accordingly, the electrode assembly may contact the second active material layer 520.

For a method of coating the case of the secondary battery with an active material layer, the second active material layer 520 may be coated by using a gravure roller.

A thickness of the second active material layer 520 may be from about 60 μm to about 70 μm.

A content of the silicon-based active material included in the second active material layer 520 may be greater than a content of the silicon-based active material included in the active material layer of the first electrode or the second electrode included in the electrode assembly. The second active material layer 520 may have a content of the silicon-based active material greater than or equal to 30 wt %. Accordingly, the electrode assembly and the second active material layer 520 applied to the case cover 121 may maintain contact with each other.

In some embodiments, the thickness of the second active material layer 520 may be at least 102% of the thickness of the active material layer applied to a surface of at least one of the first electrode or the second electrode included in the electrode assembly. In some embodiments, the coating area of the second active material layer 520 may be at least 110% of the area of the active material layer coated onto a surface of the first electrode or the second electrode. Accordingly, the energy density and capacity of the secondary battery may be increased.

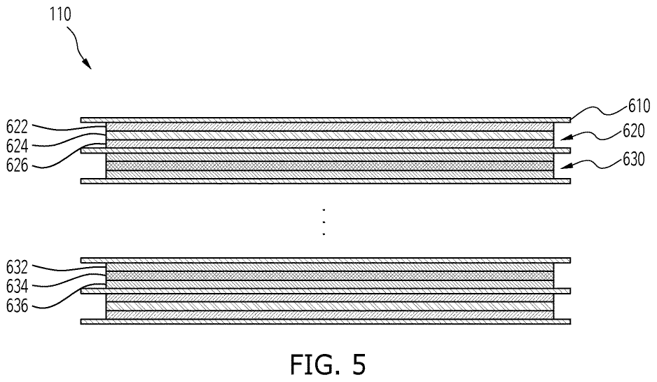

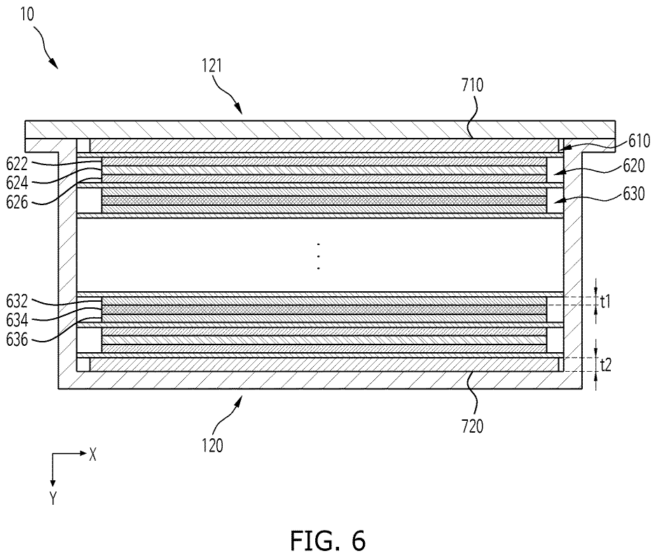

FIG. 5 is a cross-sectional view illustrating an electrode assembly 110 according to some embodiments of the present disclosure. FIG. 6 is a cross-sectional view illustrating a secondary battery 10 according to some embodiments of the present disclosure.

Referring to FIG. 5, an electrode assembly 110 may include at least one first electrode 620, at least one second electrode 630, and at least one separator 610. The electrode assembly 110 may be a stacked-type electrode assembly 110 in which the at least one first electrode 620, the at least one separator 610, and the at least one second electrode are sequentially stacked. As shown in FIG. 5, the number of first electrodes 620, separators 610, and second electrodes 630 is not limited by FIG. 5 and may be any number of first electrodes, separators, and second electrodes, together constituting the electrode assembly 110.

The first electrode 620 may include first active material layers 622 and 626 disposed on a first substrate 624 and at least part of the first substrate 624. The first active material layers 622 and 626 may be disposed on at least one of a first surface of the first substrate 624 or a second surface of the first substrate 624 that faces the first surface of the first substrate 624. The first electrode 620 may be a positive electrode plate, and the first active material layers 622 and 626 may be positive electrode active material layers.

The second electrode 630 may include second active material layers 632 and 636 disposed on a second substrate 634 and at least part of the second substrate 634. The second active material layers 632 and 636 may be disposed on at least one of a first surface of the second substrate 634 or a second substrate of the second substrate 634 that faces the first surface of the second substrate 634. The second electrode 630 may be a negative electrode plate, and the second active material layers 632 and 636 may be negative electrode active material layers.

Referring to FIG. 6, a secondary battery may include a case body 120 including an opening on one side for accommodating an electrode assembly, a case cover 121 configured to seal the opening of the case body 120, and an electrode assembly including at least one first electrode 620, at least one second electrode 630, and at least one separator 610. Although FIG. 6 illustrates a plurality of separators 610, the present disclosure is not limited thereto. A single separator may be bent in a zigzag pattern, and the first electrode 620 and the second electrode 630 may be disposed between bent portions of the single separator.

The case body 120 may include a first active material layer 720 coated on an inner side of the opening that faces the electrode assembly. The case cover 121 may include a second active material layer 710 coated on a surface that faces the electrode assembly.

The electrode assembly may be accommodated in the case body 120. A surface of the electrode assembly may be configured to contact the case body 120 and the case cover 121. Specifically, a surface of the electrode assembly may contact the first active material layer 720 coated on the inner side of the opening of the case body 120. Another surface of the electrode assembly 110 may contact the second active material layer 710 coated on the surface of the case cover 121 that faces the electrode assembly.

The case body 120 and the case cover 121 may include stainless steel. Accordingly, the case body 120 and the case cover 121 may be coated with an active material to function as a negative electrode. The case body 120 and the case cover 121 may function as a negative electrode current collector.

The first active material layer 720 and the second active material layer 710 may be coated by using a gravure roller. The first active material layer 720 and the second active material layer 710 may be negative electrode active material layers.

The thickness of the first active material layer 720 and the second active material layer may be from about 60 μm to about 70 μm.

The first active material layer 720 of the case body 120 and the second active material layer 710 of the case cover 121 may contact at least one separator 610 of the electrode assembly 110. The electrode assembly 110 may contact the case body 12 and the case cover 121.

A content of the silicon-based active material included in the first active material layer 720 and the second active material layer 710 may be greater than a content of the silicon-based active material included in the active material layers 622, 626, 632 and 636 of the first electrode 620 or the second electrode 630 included in the electrode assembly 110. A content of the silicon-based active material in the first active material layer 720 and the second active material layer 710 may be greater than or equal to 30 wt %. Accordingly, the first active material layer 720 and the second active material layer 710 coated onto the electrode assembly 110 and the case body 120 may maintain contact with the electrode assembly 110.

A thickness t2 of the first active material layer 720 and the second active material layer 710 may be at least 102% of a thickness t1 of the active material layers 622, 626, 632 and 636 coated on a surface of at least one of the first electrode or the second electrode included in the electrode assembly. Accordingly, the energy density and capacity of the secondary battery may increase. FIG. 6 illustrates the thicknesses t1 and t2 may respectively be the thicknesses of the active material layer 632 and the first active material layer 720 coated on a surface of the second electrode. However, the present disclosure is not limited thereto, and the thicknesses t1 and t2 may respectively be the thicknesses of the active material layer 622 and the second active material layer 710 coated on a surface of the first electrode.

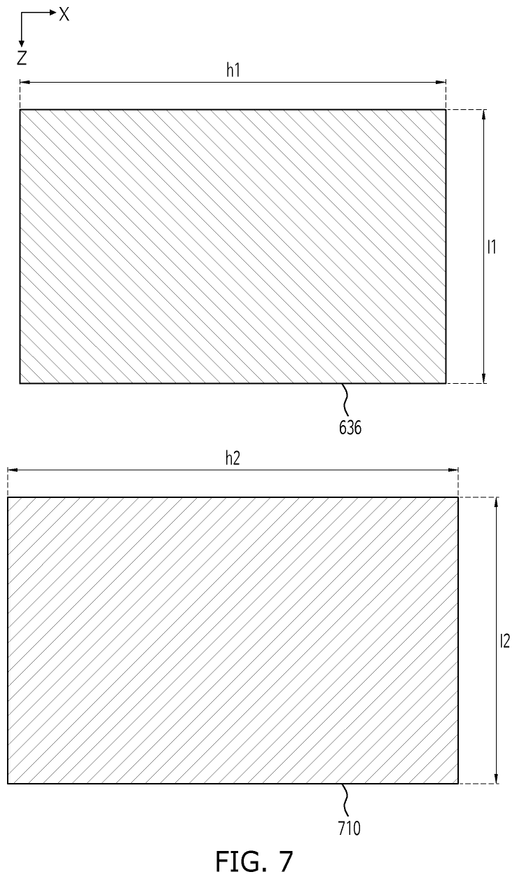

FIG. 7 is a view illustrating differences in width, length, and area between the second active material layer 710 applied to the case cover and the active material layer 636 of the second electrode according to some embodiments of the present disclosure.

FIG. 7 illustrates, on the left side, the active material layer 636 coated on at least a surface of the active material layer of the second electrode, and the second active material layer 710 coated on the case cover on the right side. However, the present disclosure is not limited thereto, and the active material layer on the left side may be the active material layers (e.g., 622 and 626 of FIG. 6) coated on at least a surface of the first electrode in FIG. 6. The active material layer on the right side may be the first active material layer (e.g., 720 of FIG. 6) coated on an inner side of the opening of the case body 120 of FIG. 6.

Coating areas of the first active material layer and the second active material layer 710 may be at least 110% of the area of the active material layer 636 coated on the surface of at least one of the first electrode or the second electrode.

A length 12 in the first direction (e.g., z direction) of the first active material layer and the second active material layer 710 may be greater than a length 11 in the first direction of the active material layer 636 coated on the surface of at least one of the first electrode or the second electrode. A length h2 of the first active material layer and the second active material layer 710 in the second direction (e.g., X direction) perpendicular to the first direction may be greater than a length h1 in the second direction of the active material layer 636 applied to the surface of at least one of the first electrode or the second electrode. The length 12 of the first active material layer and the second active material layer 710 in the first direction may be at least 102% of the length 11 of the active material layer 636 applied to a surface of at least one of the first electrode or the second electrode in the first direction. In addition, the length h2 of the first active material layer and the second active material layer 710 in the second direction perpendicular to the first direction may be at least 102% of the length h1 of the active material layer 636 applied to a surface of at least one of the first electrode or the second electrode in the second direction.

In some above-described embodiments, even when the electrode assembly moves within the case, contact between the electrode assembly and the first active material layer and the second active material layer 710 inside the case may be achieved and/or maintained.

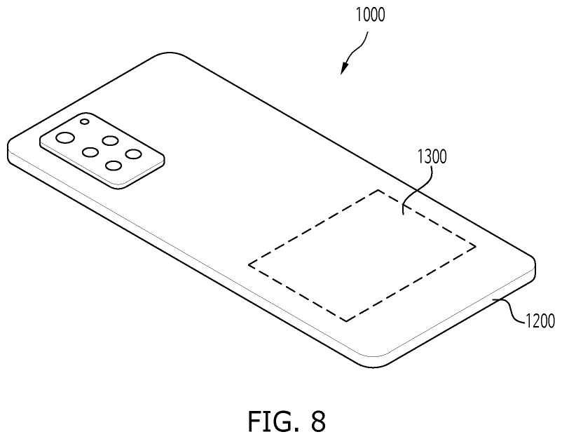

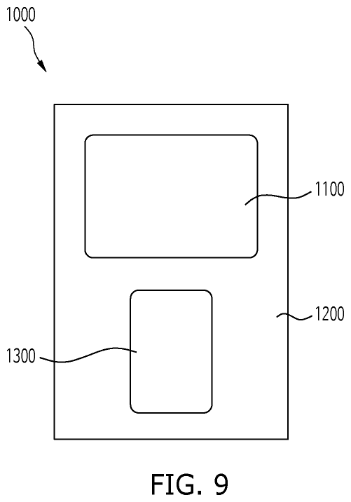

FIG. 8 is a schematic view illustrating a battery electronic device 1000 according to some embodiments of the present disclosure. FIG. 9 is a view illustrating a battery module 1300 arranged in a battery electronic device according to some embodiments of the present disclosure.

A battery electronic device 1000 according to some embodiments of the present disclosure may include an operator 1100 that performs a set operation, a housing 1200 that accommodates the operator 1100, and a battery module 1300 fixed in the housing 1200 to supply power to the operator 1100.

The battery electronic device 1000 including the battery module 1300 may be smartphones, but the battery electronic device 1000 including the battery module 1300 is not limited thereto. The battery electronic device including the battery module 1300 may be used in various devices that use electrical energy stored in the battery module 1300 and may require protective circuits.

The operator 1100 may include various hardware that is driven by receiving electrical energy from the battery module 1300. The operator 1100 may include an application processor (AP) and/or a central processing unit (CPU) of a portable electronic device.

A printed circuit substrate (not shown) including a signal transmission wire may be provided inside the housing 1200, and the operator 1100 may be mounted on the printed circuit substrate and electrically connected to other components of the battery electronic device 1000.

The housing 1200 may accommodate the operator 1100 and the battery module 1300 and may define the exterior of the battery electronic device 1000. The housing 1200 may have various structures as long as the housing 1200 supports and protects the operator 1100 and the battery module 1300 from external impacts.

The battery module 1300 may be fixed into the inside of the housing 1200 and may stably supply power to the operator 1100. The battery module 1300 may be configured with a chargeable secondary battery. Accordingly, the battery module 1300 may have substantially the same configuration as the secondary battery 10 described with reference to FIGS. 1 and 2.

The battery module 1300 may be arranged in a power source area inside the housing 1200 and may be connected to the terminal of the printed circuit substrate. Accordingly, the operator 1100 may be driven by using electrical energy stored in the secondary battery.

The battery module 1300 may include an electrode assembly including at least one first electrode, at least one second electrode, and at least one separator, a case body having an opening on one side and configured to accommodate the electrode assembly, and a case cover configured to seal the opening of the case body. The case body may include the first active material layer coated on the inner side of the opening that faces the electrode assembly. The case cover may include the second active material layer coated on a surface that faces the electrode assembly.

Although the present disclosure has been described with reference to some embodiments and drawings illustrating some aspects thereof, the present disclosure is not limited thereto. Various modifications to and variations of some embodiments of the present disclosure can be made by a person skilled in the art to which the present disclosure belongs.

### DESCRIPTION OF NOTATIONS

10: Battery Module
100: Battery Cell
110: Electrode Assembly
120: Case Body
121: Case Cover
130: First Electrode Terminal
140: Second Electrode Terminal
310: Case Body Side Part
320: Flange Part
330: First Active Material Layer
OP: Opening
510: Case Cover Edge
520: Second Active Material Layer
610: Separator
620: First Electrode
622: First Active Material Layer
624: First Substrate
626: First Active Material Layer
630: Second Electrode
632: Second Active Material Layer
634: Second Substrate
636: Second Active Material Layer
710: Second Active Material Layer
720: First Active Material Layer
1300: Battery Module
1000: Battery Electronic Device

What is claimed is:

1. A secondary battery comprising:
an electrode assembly comprising a first electrode, a second electrode, and a separator;
a case body having an opening on a side of the case body and accommodating the electrode assembly, the case body comprising a first active material layer coated on an inner side of the opening that faces the electrode assembly; and
a case cover sealing the opening of the case body, the case cover comprising a second active material layer coated on a surface of the case cover that faces the electrode assembly.

2. The secondary battery as claimed in claim 1, wherein the electrode assembly contacts the case body and the case cover.

3. The secondary battery as claimed in claim 2, wherein a surface of the electrode assembly contacts the first active material layer coated on the inner side of the opening of the case body, and
wherein another surface of the electrode assembly contacts the second active material layer coated on the surface of the case cover.

4. The secondary battery as claimed in claim 2, wherein the first active material layer of the case body and the second active material layer of the case cover contact the separator of the electrode assembly.

5. The secondary battery as claimed in claim 1, wherein the electrode assembly is a stacked-type electrode assembly where the first electrode, the separator, and the second electrode are sequentially stacked.

6. The secondary battery as claimed in claim 1, wherein the case body and the case cover comprise stainless-use steel.

7. The secondary battery as claimed in claim 1, wherein a content of a silicon-based active material comprised in the first active material layer or comprised in the second active material layer is greater than a content of the silicon-based active material comprised in an active material layer of the first electrode or an active material layer of the second electrode.

8. The secondary battery as claimed in claim 1, wherein the first active material layer and the second active material layer each have a content of silicon-based active material greater than or equal to 30 wt %.

9. The secondary battery as claimed in claim 1, wherein a thickness of the first active material layer or a thickness of the second active material layer is greater than a thickness of an active material layer coated on a surface of the first electrode or a thickness of an active material layer coated on a surface of the second electrode.

10. The secondary battery as claimed in claim 1, wherein a thickness of the first active material layer or a thickness of the second active material layer is at least 102% of a thickness of an active material layer coated on a surface of the first electrode or a thickness of an active material layer coated on a surface of the second electrode.

11. The secondary battery as claimed in claim 1, wherein a coating area of the first active material layer or a coating area of the second active material layer is greater than an area of an active material layer coated on a surface of the first electrode or an area of an active material layer coated on a surface of the second electrode.

12. The secondary battery as claimed in claim 1, wherein a coating area of the first active material layer or a coating area of the second active material layer is 110% of an area of an active material layer coated on a surface of the first electrode or an area of an active material layer coated on a surface of the second electrode.

13. The secondary battery as claimed in claim 1, wherein a length in a first direction of the first active material layer or a length in the first direction of the second active material layer is greater than a length in the first direction of an active material layer coated on a surface of the first electrode or a length in the first direction of an active material layer coated on a surface of the second electrode, and
wherein a length in a second direction, perpendicular to the first direction, of the first active material layer or a length in a second direction of the second active material layer is greater than a length in the second direction of the active material layer coated on the surface of the first electrode or a length in the second direction of the active material layer coated on the surface of the second electrode.

14. The secondary battery as claimed in claim 1, wherein a length in a first direction of the first active material layer or a length in a first direction of the second active material layer is at least 102% of a length in the first direction of an active material layer coated on a surface of the first electrode or a length in the first direction of an active material layer coated on a surface of the second electrode, and
wherein a length in a second direction, perpendicular to the first direction, of the first active material layer or a length in the second direction of the second active material layer is at least 102% of a length in the second direction of the active material layer coated on the surface of the first electrode or a length in the second direction of the active material layer coated on the surface of the second electrode.

15. A method of providing active material layers for the secondary battery of claim 1, the method comprising:
using a gravure roller to coat the first active material layer onto the case body; and
using a gravure roller to coat the second active material layer onto the case cover.

16. A secondary battery case comprising:
a case body having an opening on a side of the case body and accommodating an electrode assembly, the case body comprising a first active material layer coated on an inner side of the opening that faces the electrode assembly; and
a case cover sealing an opening of the case body, the case cover comprising a second active material layer coated on a surface that faces the electrode assembly.

17. The secondary battery case as claimed in claim 16, wherein the case body and the case cover comprise stainless use steel.

18. The secondary battery case as claimed in claim 16, wherein the first active material layer and the second active material layer each have a content of silicon-based active material greater than or equal to 30 wt %.

19. The secondary battery case as claimed in claim 16, wherein a thickness of the first active material layer and a thickness of the second active material layer are each from about 60 μm to about 70 μm.

20. A method of providing active material layers for the secondary battery case of claim 16, the method comprising:
using a gravure roller to coat the first active material layer onto the case body; and
using a gravure roller to coat the second active material layer onto the case cover.
